(19) United States
(12) Patent Application Publication
(10) Pub. No.: US 2025/0357044 A1
(43) Pub. Date: Nov. 20, 2025

(54) COIL BOBBIN, COIL COMPONENT, AND METHOD OF MANUFACTURING COIL BOBBIN

(71) Applicant: SUMIDA CORPORATION, Tokyo (JP)

(72) Inventors: Yosuke YANAI, Natori City (JP); Hiromitsu KURIKI, Natori City (JP)

(21) Appl. No.: 18/873,568

(22) PCT Filed: Jul. 21, 2022
(86) PCT No.: PCT/JP2022/028337

§ 371 Date: Dec. 10, 2024

(51) Int. Cl. H01F 41/098; H01F 27/30

(52) U.S. Cl. CPC H01F 41/098; H01F 27/303

(57) ABSTRACT

A coil bobbin includes a winding, a first bobbin, and a second bobbin. The first bobbin and the second bobbin are arranged side by side so that axial directions are aligned with each other. The winding is wound in a continuous manner around the first bobbin and the second bobbin and is made to traverse from the first bobbin to the second bobbin through an inside space sandwiched between the first bobbin and the second bobbin that are arranged side by side. In addition, the winding includes a slack portion in the inside space.

### CROSS REFERENCE TO RELATED APPLICATIONS

This application is a 371 U.S. National Phase of International Application No. PCT/JP2022/028337, filed on Jul. 21, 2022. The entire disclosure of the above application is incorporated herein by reference.

### BACKGROUND

### Technical Field

The present invention relates to a coil bobbin including a plurality of bobbins around which a winding is wound in a continuous manner, a coil component including the coil bobbin, and a method of manufacturing the coil bobbin.

### Related Art

There are coil components in which two bobbins are arranged side by side so as to be aligned with each other in an axial direction and a winding is wound in a continuous manner so as to straddle the two bobbins. Specifically, after the winding is wound from one end to the other end of one bobbin among the two bobbins arranged side by side, the winding is wound as it is from the other end to one end of the other contiguous bobbin.

Regarding techniques of this type, Japanese Patent Laid-Open No. 2000-182844 discloses an inductor component in which one winding (9 and 10) is wound in a continuous manner around two coil bobbins (21 and 22) arranged side by side so that axial directions are aligned with each other.

As illustrated in FIG. 1B in Japanese Patent Laid-Open No. 2000-182844, the winding (9 and 10) is wound from a lower end toward an upper end of the coil bobbin (21) on one side (for example, a left side), made to traverse from the left-side coil bobbin (21) to the right-side coil bobbin (22), and wound from an upper end toward a lower end of the right-side coil bobbin (22). More specifically, the winding (9 and 10) wound from the lower end toward the upper end of the left-side coil bobbin (21) is routed onto a collar portion (24) on an upper end side of the left-side coil bobbin (21). The winding (9 and 10) is passed above the collar portion (24) while following an outer periphery of the inductor component and is made to traverse from the left-side coil bobbin (21) to the right-side coil bobbin (22), and is wound from the upper end toward the lower end of the right-side coil bobbin (22).

Generally, a winding apparatus is used to wind a winding around a bobbin. Specifically, a wire rod supplying unit such as a nozzle for paying out a wire rod in the winding apparatus or a bobbin to be used as a winding core is rotated to wind the wire rod around an outer circumference of the bobbin. In addition, at the same time as the winding of the wire rod, the wire rod supplying unit or the bobbin is moved in an axial direction of the bobbin to wind the winding so that the winding runs in parallel on the bobbin.

In a case where a winding is wound in a continuous manner around each of two coil bobbins (21 and 22) arranged side by side so that axial directions are aligned with each other as in Japanese Patent Laid-Open No. 2000-182844, when the winding is wound around one coil bobbin, the other coil bobbin contiguous to the one coil bobbin and a part of a winding apparatus such as a wire rod supplying unit may interfere with each other. For example, when winding is to be performed by fixing a position of the wire rod supplying unit of the winding apparatus and rotating one coil bobbin, since the other coil bobbin present so as to be contiguous in a radial direction of the one coil bobbin rotates around an axis of the one coil bobbin with the rotation of the one coil bobbin, the other coil bobbin interferes with the wire rod supplying unit of the winding apparatus. In addition, even when the winding is wound by moving the wire rod supplying unit around the axis of the one coil bobbin while keeping a position of the coil bobbins fixed, the wire rod supplying unit that moves in a circumferential direction of the one coil bobbin interferes with the other contiguous coil bobbin. In order to prevent interference between the wire rod supplying unit and the coil bobbins, a gap must be provided between the two coil bobbins so that the wire rod supplying unit can pass between the two coil bobbins when the winding is being wound. However, when a gap is provided between the coil bobbins, a size of the entire coil component increases. Downsizing the coil component without providing a gap between the coil bobbins requires the winding being wound using a special winding method while avoiding interference between the wire rod supplying unit and the coil bobbin and results in a decline in efficiency of a winding step of the winding.

The present invention has been made in consideration of the problem described above and provides a method of manufacturing a coil bobbin that reduces interference between a winding apparatus and a coil bobbin in a winding step of a winding and attains high efficiency of the winding step of a winding and a coil bobbin that enables such manufacturing to be performed.

### SUMMARY

The present invention provides a coil bobbin including: a winding; and a first bobbin and a second bobbin arranged side by side so that axial directions are aligned with each other, wherein the winding: is wound in a continuous manner around the first bobbin and the second bobbin; made to traverse from the first bobbin to the second bobbin through an inside space sandwiched between the first bobbin and the second bobbin arranged side by side; and includes a slack portion in the inside space.

The present invention provides a coil component which includes: the coil bobbin described above; and a core that includes a magnetic leg inserted into each of the first bobbin and the second bobbin in a winding shaft direction of the winding and that is constructed by combining a plurality of magnetic members, wherein the first bobbin and the second bobbin include: a winding shaft portion around which the winding is wound; and a flange portion that is respectively formed at one end section and another end section of the first bobbin and the second bobbin and that protrudes in a direction intersecting an axial direction from the winding shaft portion, the flange portion at the one end section or the flange portion at the other end section in each of the first bobbin and the second bobbin includes a projecting portion on an outside surface on an opposite side to the winding shaft portion, and at least one of the magnetic members is arranged so as to straddle the flange portion of the first bobbin and the flange portion of the second bobbin and a projecting portion is arranged in a periphery of the magnetic member.

The present invention provides a method of manufacturing a coil bobbin including a winding and a first bobbin and a second bobbin that respectively include a winding shaft portion around which the winding is to be wound and that are arranged side by side, the method of manufacturing a coil bobbin including: winding the winding in a continuous manner around the winding shaft portion of the first bobbin and the winding shaft portion of the second bobbin in a state where the first bobbin and the second bobbin are vertically arranged so that the respective winding shaft portions are aligned in an approximately linear shape; and folding and arranging the first bobbin and the second bobbin side by side so that a traverse portion being a length region that straddles the first bobbin and the second bobbin in the winding is positioned inside.

The coil bobbin according to the invention described above can be manufactured by winding a winding in a continuous manner in a state where two bobbins are vertically arranged so as to be aligned in an approximately linear shape in an axial direction and, subsequently, folding and arranging the two bobbins side by side so that axial directions become aligned with each other. When the winding is wound in a state where the two bobbins are vertically arranged, one bobbin is not present in a radial direction of another bobbin around which the winding is being wound and interference between a winding apparatus and the coil bobbin can be prevented.

### Effects of the Invention

The coil bobbin, the coil component, and the method of manufacturing the coil bobbin according to the present invention enables interference between a winding apparatus and the coil bobbin in a winding step of a winding to be reduced and efficiency of the winding step of a winding to be increased.

### BRIEF DESCRIPTION OF THE DRAWINGS

The object described above as well as other objects, features, and advantages will be further clarified by the preferred embodiments described below and the following accompanying drawings.

FIG. 1 is a perspective view of a coil bobbin according to a first embodiment of the present invention (however, a winding is not shown in the drawing).

FIG. 2 is a perspective view of the coil bobbin according to the first embodiment (however, a second bobbin and the winding wound around the second bobbin are not shown in the drawing).

FIG. 3 is a top view of the coil bobbin according to the first embodiment.

FIG. 4 is a front view of the coil bobbin according to the first embodiment.

FIG. 5 is a longitudinal sectional view of a cross section along a dashed-dotted line shown in FIG. 3 of the coil bobbin according to the first embodiment as viewed in a direction of an arrow V-V.

FIG. 6 is a transverse sectional view of a cross section along a dashed-dotted line shown in FIG. 4 of the coil bobbin according to the first embodiment as viewed in a direction of an arrow VI-VI.

FIG. 7 is a perspective view of the coil bobbin in an expanded state according to the first embodiment.

FIG. 8 is a side view of the coil bobbin in an expanded state according to the first embodiment as viewed from a side where a recessed portion is formed.

FIG. 9 is a perspective view of a coil component according to the first embodiment.

FIG. 10 is a perspective view of the coil component according to the first embodiment (however, a terminal portion is not shown in the drawing).

FIG. 11 is a longitudinal sectional view of the coil component according to the first embodiment (however, a winding and a terminal portion are not shown in the drawing).

### DETAILED DESCRIPTION

Various constituent elements of a coil bobbin and a coil component according to the present invention need not be individually independent entities. A plurality of constituent elements may be formed as a single member, a single constituent element may be formed by a plurality of members, a given constituent element may constitute a part of another constituent element, a part of a given constituent element and a part of another constituent element may overlap with each other, and the like.

In addition, while a method of manufacturing a coil bobbin according to the present invention may be described using a plurality of sequentially described steps, the described sequence is not intended to limit a sequence or a timing of executing the plurality of steps. Therefore, when implementing the method of manufacturing a coil bobbin according to the present invention, the sequence of the plurality of steps can be changed to the extent that such a change does not interfere with contents and a part of or all of the timings at which the plurality of steps are executed may overlap with each other.

Hereinafter, an embodiment of the present invention will be described based on the drawings. In the respective drawings, corresponding constituent elements will be denoted by common reference signs and redundant descriptions will not be repeated.

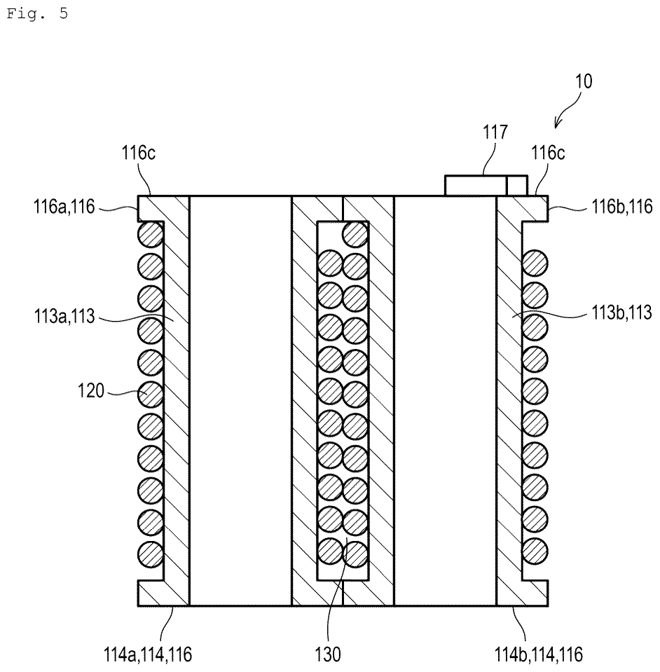

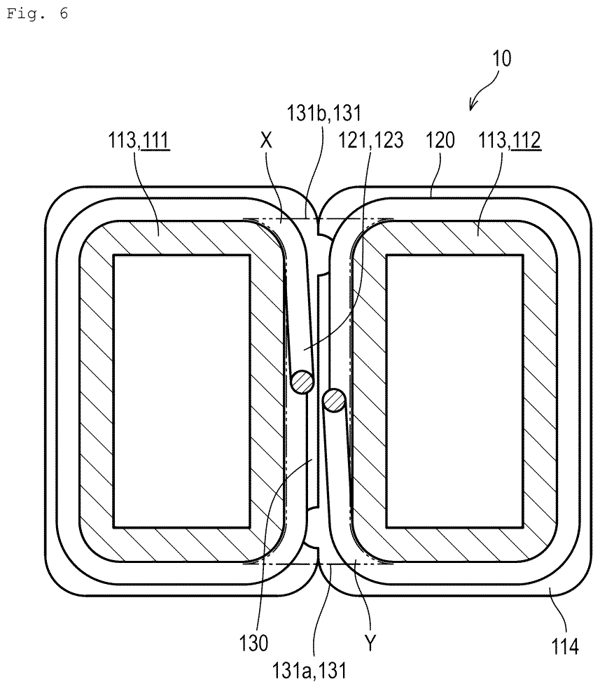

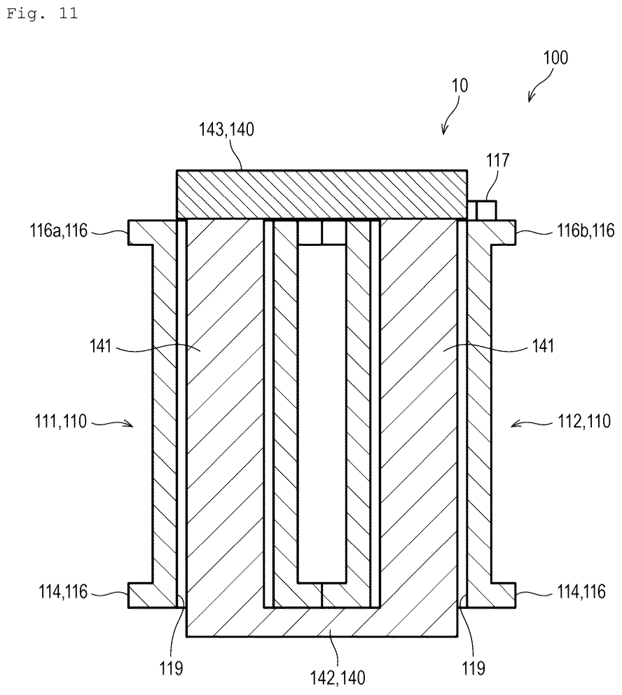

In the present embodiment, axial directions of the first bobbin and the second bobbin may be referred to as a longitudinal direction and a direction orthogonal to the longitudinal direction may be referred to as a transverse direction. In addition, in a state where the first bobbin and the second bobbin are arranged side by side, a direction orthogonal to both a direction in which a first bobbin 111 and a second bobbin 112 are aligned and the longitudinal direction may be referred to as a front-rear direction of a coil bobbin 10 and bobbins 110. For example, a back-and-forth direction between a far side and a near side of a paper surface in FIG. 5 and an up-down direction of a paper surface in FIG. 6 represent the front-rear direction. Furthermore, a side including a projecting region and a recessed portion in the coil bobbin 10 and the bobbins 110 in a folded state will be referred to as an “upper side” and an opposite side will be referred to as a “lower side”. For example, an upper side of a paper surface represents the “upper side” and a lower side of the paper surface represents the “lower side” in FIGS. 5 and 11.

### First Embodiment

### (Coil Bobbin)

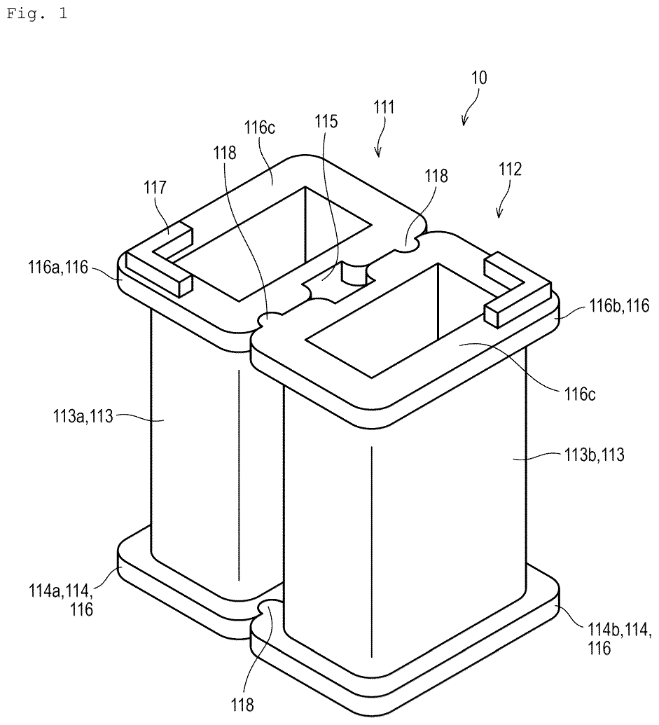

FIG. 1 is a perspective view showing an example of a coil bobbin according to a first embodiment of the present invention.

First, an overview of the coil bobbin 10 according to the present embodiment will be described.

The coil bobbin 10 includes a winding 120, a first bobbin 111, and a second bobbin 112. The first bobbin 111 and the second bobbin 112 are arranged side by side so that axial directions are aligned with each other. The winding 120 is wound in a continuous manner around the first bobbin 111 and the second bobbin 112 and is made to traverse from the first bobbin 111 to the second bobbin 112 through an inside space 130 sandwiched between the first bobbin 111 and the second bobbin 112 that are arranged side by side. In addition, the winding 120 includes a slack portion 121 in the inside space 130.

Next, the coil bobbin 10 according to the present embodiment will be described in detail.

The coil bobbin 10 is a component which includes one or a plurality of bobbins 110 and around which the winding 120 is wound. In the present embodiment, two bobbins 110 around which the winding 120 is wound may also be referred to as the coil bobbin 10. The bobbin 110 is a component to be used as winding shaft around which the winding 120 is wound. The bobbin 110 is an elongated object that is elongated in a winding shaft direction. In the present embodiment, the coil bobbin 10 includes the first bobbin 111 and the second bobbin 112 as bobbins 110. Axial directions of the first bobbin 111, the second bobbin 112, and a winding shaft portion 113 to be described later represent a direction in which the first bobbin 111 or the second bobbin 112 extends.

While a transverse cross section of the bobbin 110 has a rectangular shape in the present embodiment, alternatively, the transverse cross section may have a circular shape, a square shape, or a polygonal shape. In addition, while the bobbin 110 according to the present embodiment is a straight-axis bobbin of which a center line of a winding shaft is linear, the bobbin 110 may have a non-linear shape such as an arc shape. For example, each of two bobbins may have a semicircular shape and the two bobbins 110 may form an annular shape as a whole when the two bobbins 110 are arranged side by side. The winding 120 is a wire rod that is wound around the first bobbin 111 and the second bobbin 112. The winding 120 is made up of a metallic conductor such as copper and aluminum.

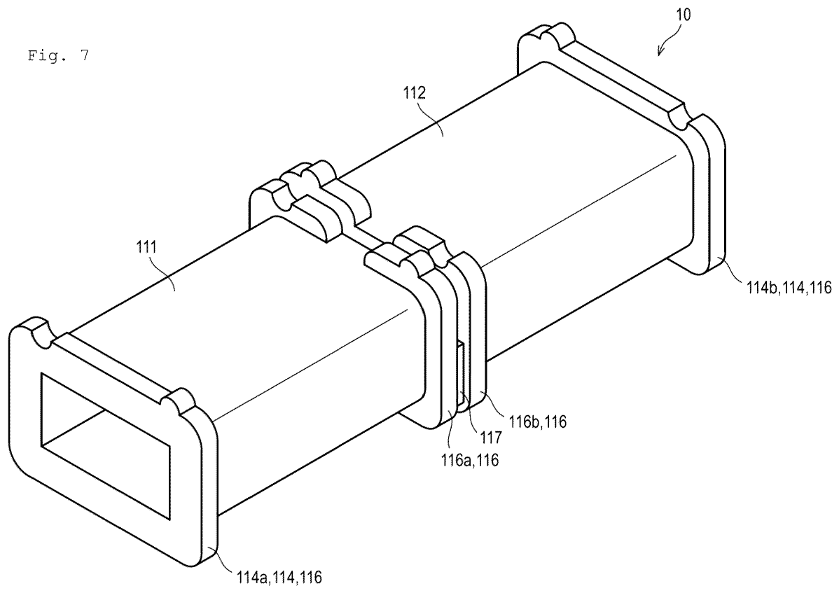

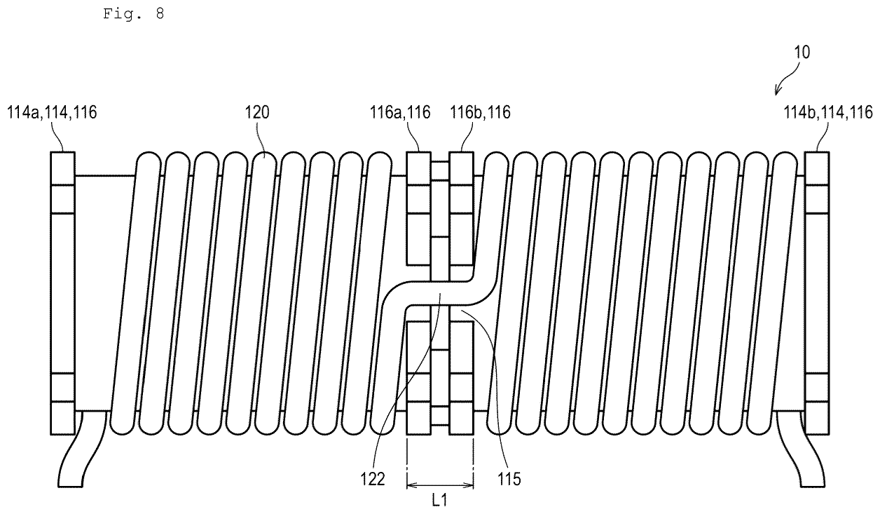

In this case, the first bobbin 111 and the second bobbin 112 being side by side so that axial directions are aligned with each other means that a winding shaft direction of one (for example, the first bobbin 111) of the two bobbins includes a winding shaft direction component of the other bobbin (the second bobbin 112). Preferably, with the first bobbin 111 and the second bobbin 112, the winding shaft direction of one bobbin includes a winding shaft direction component that is larger than an orthogonal component with respect to the winding shaft direction of the other bobbin. More preferably, the first bobbin 111 and the second bobbin 112 are parallel or substantially parallel to each other. An axial direction of the first bobbin 111 and an axial direction of the second bobbin 112 need not be completely parallel and may intersect each other or may be in a skewed state. Hereinafter, a state where the first bobbin 111 and the second bobbin 112 are arranged side by side so that axial directions are aligned with each other as in FIG. 1 may be referred to as a folded state. In addition, while the first bobbin and the second bobbin are arranged in an approximately linear shape in the axial direction as in FIGS. 7 and 8 in a winding step in a method of manufacturing a coil bobbin to be described later, the arranged state may be referred to as an expanded state.

As indicated by a dashed-two dotted line in FIG. 6, the inside space 130 is a space sandwiched between the first bobbin 111 and the second bobbin 112 in a state where the first bobbin 111 and the second bobbin 112 are arranged side by side. In the present embodiment, flange portions 116 (an upper flange portion 116 and a lower flange portion 114) to be described later are formed at both tips of the first bobbin 111 and the second bobbin 112 and respective upper flange portions 116 and respective lower flange portions 114 are in contact with each other. The inside space 130 according to the present embodiment is a space that is sandwiched between the upper flange portions 116 and the lower flange portions 114 and also sandwiched between the respective winding shaft portions 113 of the first bobbin 111 and the second bobbin 112.

As shown in FIG. 6, the inside space 130 includes at least two opening surfaces 131 in the transverse direction. The opening surfaces 131 are virtual surfaces connecting a most protruding portion in the front-rear direction of the first bobbin 111 and a most protruding portion in the same direction of the second bobbin 112 when the two bobbins 110 are in the folded state. In the present embodiment, as shown in FIG. 6, one opening surface 131 (131a) is a virtual surface connecting a circumferential surface of the winding shaft portion 113 on a front side (lower side of a paper surface) of the first bobbin 111 and a circumferential surface of the winding shaft portion 113 on a front side of the second bobbin 112 and the other opening surface 131 (131b) is a virtual surface connecting a circumferential surface of the winding shaft portion 113 on a rear side (upper side of the paper surface) of the first bobbin 111 and a circumferential surface of the winding shaft portion 113 on a rear side of the second bobbin 112.

The inside space 130 according to the present embodiment is demarcated by side surfaces that oppose each other in the first bobbin 111 and the second bobbin 112, the upper flange portions 116 and the lower flange portions 114 of the first bobbin 111 and the second bobbin 112, and the opening surfaces 131 (131a and 131b).

When the bobbins 110 do not include the flange portions 116, a breadth in the axial direction of the inside space 130 extends to both ends in the axial direction of the first bobbin 111 and the second bobbin 112. The breadth in the axial direction of the inside space 130 also extends to both ends in the axial direction of the first bobbin 111 and the second bobbin 112 when the flange portions are provided midway along the axial direction instead of at end sections of the bobbins 110 and the winding is wound around both sides.

In this case, the winding 120 being wound in a continuous manner around the first bobbin 111 and the second bobbin 112 means that a single common winding 120 is wound around each of the first bobbin 111 and the second bobbin 112. Specifically, an end at an upper end of a first winding shaft portion 113a (the winding shaft portion 113 of the first bobbin 111) in the winding 120 wound around the first winding shaft portion 113a and an end at an upper end of a second winding shaft portion 113b (the winding shaft portion 113 of the second bobbin 112) in the winding 120 wound around the second winding shaft portion 113b are connected to each other.

In this case, the winding 120 that traverses between the first bobbin 111 and the second bobbin 112 in the folded state of the first bobbin 111 and the second bobbin 112 will be referred to as a boundary portion 123. Specifically, the winding 120 in a length region connecting a point of separation from the first winding shaft portion 113a on an upper end side in the winding 120 wound around the first winding shaft portion 113a and a point of separation from the second winding shaft portion 113b on an upper end side in the winding 120 wound around the second winding shaft portion 113b is the boundary portion 123. The boundary portion 123 according to the present embodiment in the winding 120 in a length region from a position X (refer to FIG. 6) where the winding 120 separates from the first bobbin 111 after winding around the first bobbin 111 ends in the winding 120 to a position Y (refer to FIG. 6) where the winding 120 comes into contact with the second bobbin 112 and winding around the second bobbin 112 starts. The boundary portion 123 includes a traverse portion 122 (refer to FIG. 8) to be described later.

The winding 120 being made to traverse from the first bobbin 111 to the second bobbin 112 through the inside space 130 means that at least a part of the boundary portion 123 is present in the inside space 130. Specifically, as shown in FIG. 6, one end of the boundary portion 123 present in the inside space 130 communicates with outside of the inside space 130 through one opening surface 131a of the inside space 130 and another end of the boundary portion 123 present in the inside space 130 communicates with outside of the inside space 130 through the other opening surface 131b of the inside space 130. A part of the boundary portion 123 may be present outside of the inside space 130.

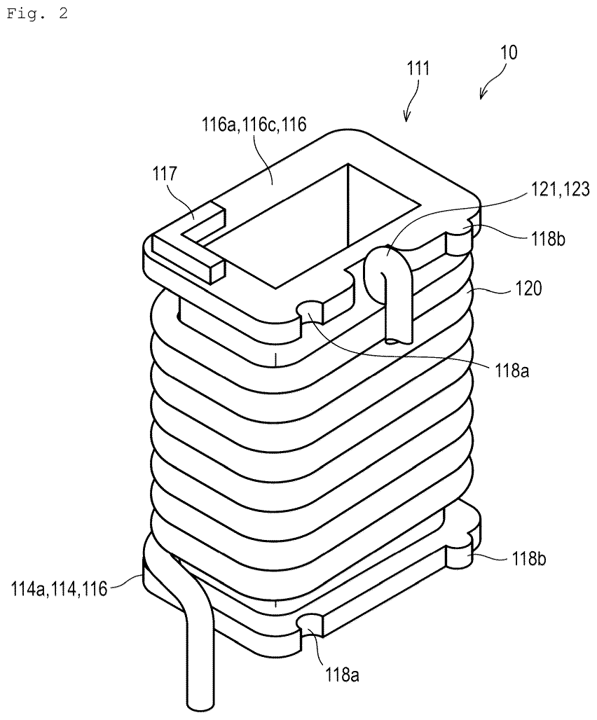

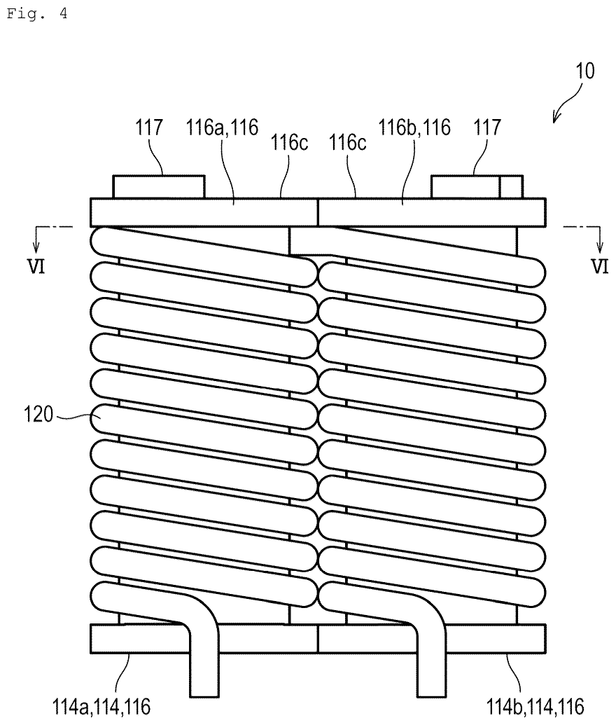

A part of the boundary portion 123 includes a bent part as illustrated in FIG. 2. While a cross section of the winding 120 is shown midway along the boundary portion 123 in FIG. 6, this is because the bent part protrudes from the cross section shown in FIG. 4 to the outside. While the cross section of the winding 120 is schematically shown with a circular shape, in reality, the cross section may have an elliptical shape.

In the present embodiment, for example, the winding 120 is wound in a continuous manner around the two bobbins 110 as follows. The winding 120 is wound around the first winding shaft portion 113a in a clockwise direction when the first bobbin 111 is viewed from above from the lower end to the upper end in the axial direction of the first bobbin 111. Next, the winding 120 is made to traverse to the upper end of the second winding shaft portion 113b through the inside space 130 that is sandwiched between the first bobbin 111 and the second bobbin (in FIG. 4, through a space between the first bobbin 111 and the second bobbin 112 from a far side of the paper surface to a near side of the paper surface). Next, the winding 120 is wound around the second winding shaft portion 113b in a counterclockwise direction when the second bobbin 112 is viewed from above from the upper end to the lower end of the second bobbin 112.

A winding direction of the winding 120 is not limited to these directions. For example, the winding 120 may be wound around the first winding shaft portion 113a in a counterclockwise direction when the first bobbin 111 is viewed from above and the winding 120 may be wound around the second winding shaft portion in a clockwise direction when the second bobbin 112 is viewed from above.

A coil component 100 with a closed magnetic circuit structure is obtained by mounting a core 140 (a U core 142 and an I core 143) to be described later to the coil bobbin 10. In the coil component 100, a line of magnetic force generated by a coil passes through the core and forms a loop. By winding the winding 120 so that winding directions of the winding 120 in the first winding shaft portion 113a and the second winding shaft portion 113b assume mutually opposite directions when the coil bobbin 10 is viewed from a same side (for example, above), the coil component 100 in which the winding 120 is wound in a same direction relative to a direction of the line of magnetic force is constructed.

In this case, a slack portion 121 is a partial length region of the winding 120 in the boundary portion 123 or a vicinity thereof and is a region where the winding 120 is slacked as compared to other length regions of the winding 120 wound around an intermediate portion of the winding shaft portions 113 or a vicinity thereof. A specific slack portion 121 is the winding 120 in a length region corresponding to any of a portion where tension lower than the winding 120 wound around a lower end side in the winding shaft portion 113 is applied in the winding 120 in the boundary portion 123 or a vicinity thereof, the boundary portion 123 in which the winding 120 does not have a linearly shape, and a portion where a winding diameter is larger than the winding 120 wound around a lower end side in the winding shaft portion 113. In this case, the winding 120 wound around a lower end side in the winding shaft portion 113 refers to, for example, the winding 120 wound around an intermediate portion of the first winding shaft portion 113a or the second winding shaft portion 113b or a vicinity thereof.

As shown in FIG. 2 according to the present embodiment, the boundary portion 123 does not have a linear shape and includes a bent part. Specifically, the boundary portion 123 has an excess length by the length of the traverse portion 122 to be described later and the winding 120 of the excess length is folded midway along the boundary portion 123. In the present embodiment, the boundary portion 123 constitutes the slack portion 121.

While an aspect in which only the boundary portion 123 between the first bobbin 111 and the second bobbin 112 constitutes the slack portion 121 is shown in the present embodiment, the slack portion 121 is not limited thereto. For example, the winding 120 that is wound around the first bobbin 111 and the second bobbin 112 may also constitute the slack portion 121. For example, due to the boundary portion 123 having an excess length, winding of the winding 120 may become loose in a radial direction on an upper end side of the first winding shaft portion 113a or the second winding shaft portion 113b. In this case, the radial direction is a direction radially from an axial center toward a circumferential edge of the bobbin 110. Hereinafter, the direction described above will be referred to as a radial direction even when cross sections of the winding shaft portions 113 and the flange portions 116 are polygonal shapes instead of circular shapes.

When loosening of the winding causes the winding 120 wound around the upper end of the winding shaft portion 113 to be wound with a lower tension than the winding 120 wound around the intermediate portion of the winding shaft portion 113, the partial length region of the winding 120 is also included as the slack portion 121. In this case, the winding 120 to become the slack portion 121 that is wound around the winding shaft portion 113 may or may not be in contact with the winding shaft portion 113. In addition, when loosening of the winding causes the winding diameter of the winding 120 that is wound around the upper end of the winding shaft portion 113 to be larger than the winding 120 wound around the intermediate portion of the winding shaft portion 113, the winding 120 that is wound around the winding shaft portion 113 with a larger winding diameter than the intermediate portion of the winding shaft portion 113 is also included as the slack portion 121.

In the present embodiment, the slack portion 121 is twisted with respect to a direction in which the winding 120 extends. Specifically, the slack portion 121 is twisted by an angle by which the first bobbin 111 and the second bobbin 112 rotate in a folding step to be described later. For example, when the first bobbin 111 and the second bobbin 112 in an expanded state are folded in the folding step by 180 degrees so that the first bobbin 111 and the second bobbin 112 are arranged side by side, the slack portion 121 is twisted by 180 degrees.

When the first bobbin 111 and the second bobbin 112 are folded from the expanded state, the traverse portion 122 to be described later is also folded. As shown in FIG. 2, in the present embodiment, the traverse portion 122 (refer to FIG. 8) has a folded shape even in a folded state. This is because the traverse portion 122 with the folded shape is prevented from assuming a linear shape due to a direction of rotation that acts on the winding 120 when the slack portion 121 attempts to eliminate the twisting and a direction of rotation that acts when the traverse portion 122 with the folded shape attempts to assume a linear shape are opposite directions. In this manner, due to the slack portion 121 being twisted, the traverse portion 122 to be described later can be readily kept in a folded shape. Accordingly, the winding 120 wound around the winding shaft portion 113 by the winding 120 with the excess length corresponding to the traverse portion 122 can be prevented from becoming loose.

Due to the winding 120 being twisted, the boundary portion 123 may assume an approximately linear shape, tension of the winding 120 that is wound around the upper end of the winding shaft portion 113 may become equivalent to the winding 120 that is wound around the intermediate portion of the winding shaft portion 113, or the winding diameter of the winding 120 may be prevented from becoming larger than the winding 120 that is wound around the intermediate portion of the winding shaft portion 113. In this case, the partial length region where the winding 120 is twisted is considered to be the slack portion 121.

Preferably, regardless of the presence or absence of twisting, the slack portion 121 is, in the winding 120 on the upper end side of the winding shaft portion 113, a portion where tension lower than the winding 120 wound around the lower end side in the winding shaft portion 113 is applied as described above, the boundary portion 123 in which the winding 120 does not have a linearly shape, or a portion where a winding diameter is larger than the winding 120 wound around the lower end side in the winding shaft portion 113.

Due to the winding 120 including the slack portion 121 and a portion that traverses from the first bobbin 111 to the second bobbin 112 having an excess length, the coil bobbin 10 can be manufactured by a manufacturing method in which the first bobbin 111 and the second bobbin 112 are placed in the expanded state and the winding 120 is wound in a continuous manner as will be described later.

In addition, due to the winding 120 traversing from the first bobbin 111 and the second bobbin 112 through the inside space 130, the coil bobbin 10 can be manufactured by a manufacturing method to be described later in which the winding 120 is wound in a same direction in a continuous manner around the first bobbin 111 and the second bobbin 112 in the expanded state.

Due to a part of the slack portion 121 being arranged in the inside space 130 of the first bobbin 111 and the second bobbin 112, the slack portion 121 is prevented from being exposed to the outside of the coil bobbin 10. Accordingly, a situation where the slack portion 121 becomes disconnected or worn down and causes performance of the coil component 100 to drop and insulation distance to unexpectedly decrease can be suppressed.

The first bobbin 111 and the second bobbin 112 include the winding shaft portion 113 around which the winding 120 is wound. The first bobbin 111 and the second bobbin 112 include a projecting region that extends in a circumferential direction of the winding shaft portion 113 in one end sections of the first bobbin 111 and the second bobbin 112.

The winding shaft portion 113 refers to a portion of the first bobbin 111 or the second bobbin 112 around which the winding 120 is wound. When the first bobbin 111 and the second bobbin 112 include the projecting region such as the flange portion 116 to be described later, the winding shaft portion 113 is a region on a center side in the axial direction than the projecting region such as the flange portion 116. When the first bobbin 111 and the second bobbin 112 include the flange portions 116 (the upper flange portion 116 and the lower flange portion 114) at both end sections, the winding shaft portion 113 is a region sandwiched between the upper flange portion 116 and the lower flange portion 114.

The projecting region refers to a region that includes a projection that protrudes in a direction intersecting the axial direction from the winding shaft portion 113 and that circles the winding shaft portion 113 in a circumferential direction thereof including the projection. In the present embodiment, while the projecting region is formed at tips of the first bobbin 111 and the second bobbin 112, the projecting region may be provided midway along the length in the axial direction of the first bobbin 111 and the second bobbin 112. While an aspect in which an entire region of the projecting region is a projection as shown in FIG. 1 or, in other words, an aspect in which the projecting region is the flange portion 116 to be described later is shown in the present embodiment, the projecting region is not limited thereto. For example, a projection may be provided only in a part of the projecting region and the projecting region other than the projection may be continuous with a circumferential surface of the winding shaft portion 113. Alternatively, the projecting region may include a plurality of projections.

The projecting region (upper flange portion 116) includes a recessed portion 115 that is formed in a recessed shape from an outer circumferential edge of the projecting region toward the winding shaft portion 113. The recessed portion 115 is provided on the projection of the projecting region and constitutes a portion of the upper flange portion 116 that forms the recessed shape. The winding 120 is passed through the recessed portion 115 in a winding step of the winding 120 to be described later.

A height in the radial direction of the recessed portion 115 based on the circumferential surface of the winding shaft portion 113 need only be lower than a height of the projection of the projecting region. The height may be higher than the height of the circumferential surface of the winding shaft portion 113 or the same as the height of the circumferential surface of the winding shaft portion 113. The first bobbin 111 and the second bobbin 112 are arranged so that at least a part of the respective recessed portions 115 is inside between the first bobbin 111 and the second bobbin 112. In this case, at least a part of the recessed portions 115 being inside between the first bobbin 111 and the second bobbin 112 means that at least a part of an opening of the recessed portion 115 is sandwiched between the first bobbin 111 and the second bobbin 112. The opening of the recessed portion 115 is a virtual circumferential edge of the projecting portion in a case where the recessed portion 115 is not formed in the projecting portion.

In the present embodiment, the recessed portion 115 of the first bobbin 111 and the recessed portion 115 of the second bobbin 112 oppose each other. In other words, the recessed portion 115 of the first bobbin 111 and the recessed portion 115 of the second bobbin 112 are provided at a same height in the axial direction of the first bobbin 111 and the second bobbin 112 and oppose each other in the circumferential direction of the first bobbin 111 and the second bobbin 112 and, when viewed from the upper surface of the coil bobbin 10, the recessed portions 115 of the first bobbin 111 and the second bobbin 112 are connected to each other. However, the recessed portion 115 of the first bobbin 111 and the recessed portion 115 of the second bobbin 112 are not limited thereto and need not oppose each other. In other words, the recessed portion 115 of the first bobbin 111 and the recessed portion 115 of the second bobbin 112 may be provided by being shifted in the circumferential direction or the axial direction of the first bobbin 111 and the second bobbin 112.

Providing the projecting region and providing the recessed portion 115 in the projecting region realizes a structure that enables the winding step in the method of manufacturing the coil bobbin 10 to be described later to be performed. In other words, by passing the winding 120 through the respective recessed portions 115 of the first bobbin 111 and the second bobbin 112 in the winding step, a position of the winding 120 (the traverse portion 122 to be described later) that traverses from the first bobbin 111 to the second bobbin 112 in the expanded state can be determined. Accordingly, a transverse shift of the winding 120 in the folding step in which the first bobbin 111 and the second bobbin 112 are folded so as to be arranged side by side can be prevented and a structure that enables the folding step in which the first bobbin 111 and the second bobbin 112 are folded with the traverse portion 122 positioned inside to be performed can be realized.

A width (dimension in the circumferential direction) of the recessed portions 115 may be a narrow width that is almost equal to the outer diameter of the winding 120 or a length that exceeds the outer diameter of the winding. In order to prevent a transverse shift of the winding 120 in the folding step, a width of the recessed portions 115 may be set to a length equal to or less than a quarter of a length of an entire circumference of the projecting region. In addition, in order to more favorably prevent a transverse shift of the winding 120, the width of the recessed portions 115 may be set equal to or less than twice the outer diameter of the winding 120. In order to prevent a transverse shift of the winding 120, a depth of the recessed portions 115 in the radial direction of the winding shaft portion 113 may be set to a length equal to or more than a diameter of a cross section of the winding 120.

In addition, by providing the projecting region, a situation where the winding 120 is locked by the projection and becomes loose toward an opposite side to the winding shaft portion 113 from the projecting region can be suppressed. When the projection is provided in plurality in the projecting region, the winding 120 can be favorably prevented from becoming loose at a plurality of locations.

The slack portion 121 has a length that enables the winding 120 to traverse from the first bobbin 111 to the second bobbin 112 through the recessed portions 115 when the first bobbin 111 and the second bobbin 112 are arranged in a linear shape by bringing the one end sections provided with the projecting region (upper flange portion 116) into contact with each other as illustrated in FIGS. 7 and 8. The winding 120 through the recessed portions 115 means that the winding 120 is arranged so as to intersect the direction in which the projecting region extends and a part of the winding 120 is enclosed by the recessed portions 115 on a surface on which the projecting region extends.

More specifically, the length of the slack portion 121 is equal to or more than a sum of a height of a bottom of the recessed portion 115 from a circumferential surface of the winding shaft portion 113 in the first bobbin 111, a height of a bottom of the recessed portion 115 in the second bobbin 112, and a distance Li (refer to FIG. 8) from the recessed portion 115 of the first bobbin 111 to the recessed portion 115 of the second bobbin 112 in a case where the first bobbin 111 and the second bobbin 112 are arranged in a linear shape by bringing the one end sections provided with the projecting region into contact with each other. In this case, the height of the bottom of the recessed portion 115 from the circumferential surface of the winding shaft portion 113 means a height of a deepest portion of the recessed portion 115 based on the circumferential surface of the winding shaft portion 113 in the radial direction. In addition, the distance from the recessed portion 115 of the first bobbin 111 to the recessed portion 115 of the second bobbin 112 in a case where the first bobbin 111 and the second bobbin 112 are arranged in a linear shape by bringing the one end sections provided with the projecting region into contact with each other means a distance connecting points on a side of the winding shaft portion 113 of respective recessed portions 115 of the first bobbin 111 and the second bobbin 112.

In the present embodiment, since the height of the recessed portion 115 is the same as the height of the circumferential surface of the winding shaft portion 113, the height of the recessed portion 115 from the circumferential surface of the winding shaft portion 113 in the first bobbin 111 and the height of the recessed portion 115 in the second bobbin 112 are substantially zero.

When the first bobbin 111 and the second bobbin 112 are vertically arranged as shown in FIG. 7, respective recessed portions 115 are communicated with each other. In this case, the distance from the recessed portion 115 of the first bobbin 111 to the recessed portion 115 of the second bobbin 112 means a distance from an inner surface of the upper flange portion 116a (a surface on a side of the winding shaft portion 113 in the flange portion 116) in the first bobbin 111 to an inner surface of the upper flange portion 116b in the second bobbin 112. In other words, the distance from the recessed portion 115 of the first bobbin 111 to the recessed portion 115 of the second bobbin 112 includes thicknesses of the upper flange portions 116 (116a and 116b) of the first bobbin 111 and the second bobbin 112 and a length between the upper flange portion 116a of the first bobbin 111 and the upper flange portion 116b of the second bobbin 112.

In the winding step to be described later, the first bobbin 111 and the second bobbin 112 assume the expanded state and, for example, the winding 120 is wound around the first bobbin 111 and then made to traverse from the first bobbin 111 to the second bobbin 112 through the recessed portion 115 of the first bobbin 111 and the recessed portion 115 of the second bobbin 112, and wound around the second bobbin 112.

When the first bobbin 111 and the second bobbin 112 transition to the folded state, the traverse portion 122 being the winding 120 arranged between the recessed portion 115 of the first bobbin 111 and the recessed portion 115 of the second bobbin 112 in the expanded state becomes a part of the slack portion 121. In other words, due to the slack portion 121 having at least a length that enables the slack portion 121 to traverse from the first bobbin 111 to the second bobbin 112 through the recessed portions 115 in the expanded state, the coil bobbin 10 can be manufactured by the method of manufacturing the coil bobbin 10 to be described later.

More specifically, the winding 120 wound around the first winding shaft portion 113a in the expanded state rides on the recessed portion 115 in the radial direction from the circumferential surface of the first winding shaft portion 113a, traverses from the recessed portion 115 of the first bobbin 111 to the recessed portion 115 of the second bobbin 112, descends to the circumferential surface of the second winding shaft portion 113b from the recessed portion 115 of the second bobbin 112, and is wound around the second winding shaft portion 113b. In the present embodiment, since the height of the bottom of the recessed portion 115 is zero, the winding 120 wound around the first winding shaft portion 113a traverses from the recessed portion 115 of the first bobbin 111 to the recessed portion 115 of the second bobbin 112 without riding on the upper flange portion 116a in the radial direction and is wound around the second winding shaft portion 113b as it is.

The slack portion 121 has a length that is equal to or more than a sum of a height of the bottom of the recessed portion 115 from a circumferential surface of the first winding shaft portion 113a, a height of the bottom of the recessed portion 115 from a circumferential surface of the second winding shaft portion 113b, and a distance from the recessed portion 115 of the first bobbin 111 to the recessed portion 115 of the second bobbin 112. Accordingly, in the winding step, the winding 120 can ride on the recessed portion 115 of the first bobbin 111 from the circumferential surface of the first winding shaft portion 113a, traverse between the recessed portions 115 of the first bobbin 111 and the second bobbin 112, and descend to the circumferential surface of the second winding shaft portion 113b from the recessed portion 115 of the second bobbin 112.

As shown in FIGS. 4 and 5, the projecting region according to the present embodiment is the flange portion 116 that protrudes in a direction intersecting the axial direction from the winding shaft portion 113 of the first bobbin 111 or the second bobbin 112. The flange portion 116 refers to a portion that protrudes from the circumferential surface of the winding shaft portion 113 around approximately the entire circumference of the projecting region. While an aspect in which the entire circumference of the flange portion 116 excluding the recessed portion 115 of the projecting region protrudes is illustrated in the present embodiment, the flange portion 116 is not limited thereto. A part of the flange portion 116 need not protrude and may be continuous with the circumferential surface of the winding shaft portion 113. In other words, the flange portion 116 may include one or a plurality of recessed portions 115.

While the flange portion 116 protrudes at a right angle with respect to the axial direction in the present embodiment, the flange portion 116 is not limited thereto.

The winding 120 is made to traverse from the first bobbin 111 to the second bobbin 112 more to a side of the winding shaft portion 113 than an outer surface 116c of the upper flange portion 116. In the present embodiment, an entire length of the boundary portion 123 is present more to the side of the winding shaft portion 113 than the outer surface 116c of the upper flange portion 116a. In other words, the winding 120 is dissociated from the first winding shaft portion 113a more to the side of the winding shaft portion 113 than the outer surface 116c of the upper flange portion 116a, passes through the inside space 130 present more to the side of the winding shaft portion 113 than the outer surface 116c of the upper flange portion 116, comes into contact with the second winding shaft portion 113b more to the side of the winding shaft portion 113 than the outer surface 116c of the upper flange portion 116b, and starts winding. Instead of the present embodiment, a part of the slack portion 121 may be present on an opposite side to the winding shaft portion 113 of the flange portion 116. For example, when the slack portion 121 is long, a part of the slack portion 121 may protrude above the upper flange portion 116.

Providing the upper flange portion 116 by causing approximately an entire circumference of the projecting region to protrude enables the winding 120 that tends to loosen toward an outer side in the axial direction of the winding shaft portion 113 to be suitably locked around approximately an entire circumference. A height in the radial direction of the flange portion 116 is a sufficient height for locking the winding 120. Specifically, it is preferable that the height of the flange portion 116 is set equal to or more than a diameter of the cross section of the winding 120.

In addition, the recessed portion 115 according to the present embodiment is a notched portion of the flange portion 116 provided by notching the flange portion 116. Due to the flange portion 116 being provided with a notched portion, the slack portion 121 of the winding 120 can be made shorter as compared to a hypothetical case where the flange portion 116 is not provided with a notched portion and an entire circumferential range of the projecting region protrudes from the circumferential surface of the winding shaft portion 113. For example, when the flange portion 116 does not have a notched portion, since the winding 120 having been wound around the circumferential surface of the first winding shaft portion 113a rides on the upper flange portion 116a of the first bobbin 111, traverses to the upper flange portion 116b of the second bobbin 112, and descends to the circumferential surface of the second winding shaft portion 113b from the upper flange portion 116b of the second bobbin 112, the slack portion 121 requires a length corresponding to the heights of the upper flange portions 116 (116a and 116b). In consideration thereof, providing the upper flange portion 116 with the notched portion causes the height of the upper flange portion 116 that the winding 120 rides on to be reduced or become zero and the length of the slack portion 121 necessary for traversing from the first bobbin 111 to the second bobbin 112 can be reduced.

In addition, by causing an entire length of the boundary portion 123 to traverse from the first bobbin 111 to the second bobbin 112 more to the side of the winding shaft portion 113 than the outer surface 116c of the flange portion 116, a situation where the slack portion 121 unexpectedly protrudes to outside of the coil component and damages or disconnects the winding in the slack portion 121 can be prevented.

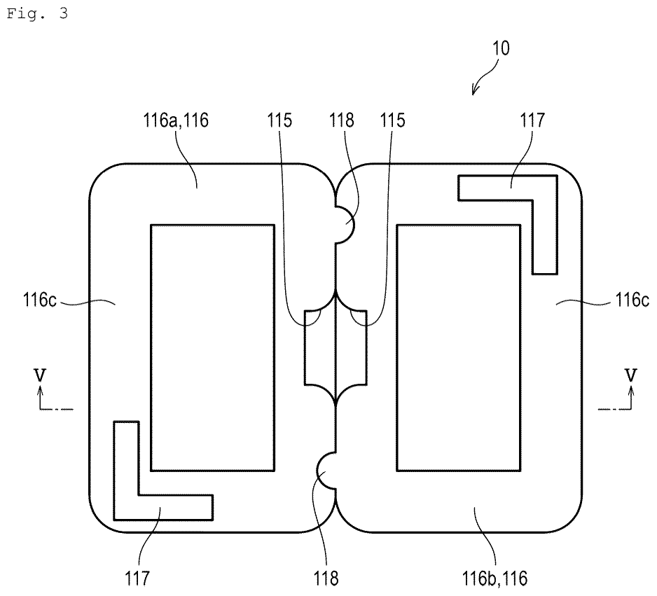

As shown in FIGS. 1 and 3, the first bobbin 111 and the second bobbin 112 include concave-convex engaging portions 118 that engage with each other in a state where the first bobbin 111 and the second bobbin 112 are arranged side by side so that axial directions are aligned with each other. The concave-convex engaging portion 118 refers to a combination of at least one pair of an engaging concave portion 118a (refer to FIG. 2) and an engaging convex portion 118b (refer to FIG. 2). The engaging concave portion 118a and the engaging convex portion 118b are provided on a side where the first bobbin 111 and the second bobbin 112 oppose each other in the folded state of the first bobbin 111 and the second bobbin 112. The engaging convex portion 118b is provided so as to protrude in the radial direction. The engaging concave portion 118a has a recessed shape that corresponds to the engaging convex portion 118b and is recessed in an axial center direction from the circumferential edge of the first bobbin 111 or the second bobbin 112. Accordingly, the engaging concave portion 118a and the engaging convex portion 118b mesh together in the folded state.

In the present embodiment, a shape of the engaging convex portion 118b is a shape that monotonously narrows in a protruding direction. Examples of the shapes of the engaging convex portion 118b and the engaging concave portion 118a include a semicircular shape and a triangular shape.

The first bobbin 111 and the second bobbin 112 include either one or the other of the engaging concave portion 118a and the engaging convex portion 118b. In other words, the first bobbin 111 and the second bobbin 112 together include one or more pairs of the concave-convex engaging portions 118.

In the present embodiment, the flange portions 116 (upper flange portion 116 and lower flange portion 114) are provided at both ends of the first bobbin 111 and the second bobbin 112 as will be described later. In addition, when the first bobbin 111 and the second bobbin 112 are in the folded state, the upper flange portions 116 and the lower flange portions 114 of the first bobbin 111 and the second bobbin 112 are respectively in contact with each other. While the engaging concave portion 118a or the engaging convex portion 118b is provided on sides adjacent to each other in the upper flange portion 116 and the lower flange portion 114 of the first bobbin 111 and the second bobbin 112, the engaging concave portion 118a or the engaging convex portion 118b is not limited thereto. The concave-convex engaging portions 118 may be provided in the winding shaft portions 113 of the first bobbin 111 and the second bobbin 112. For example, when a protrusion such as a flange is provided midway along the winding shaft portion 113 as in a modification to be described later, the concave-convex engaging portions 118 may be provided on the flanges of the first bobbin 111 and the second bobbin 112. In addition, when there is a portion protruding from the circumferential surface of the winding shaft portion 113 on an outer side in the axial direction of the flange portion 116, the concave-convex engaging portion 118 may be provided in the protruding portion.

In the present embodiment, the engaging concave portion 118a or the engaging convex portion 118b is provided in each of the upper flange portion 116 and the lower flange portion 114 in the first bobbin 111 and the second bobbin 112. Specifically, in the upper flange portion 116, two pairs of the concave-convex engaging portions 118 are provided between the first bobbin 111 and the second bobbin 112 and the lower flange portion 114 is also provided with two pairs of the concave-convex engaging portions 118. More specifically, each flange portion 116 includes one each of the engaging concave portion 118a and the engaging convex portion 118b.

The concave-convex engaging portion 118 may be provided in only the upper flange portion 116 or the lower flange portion 114 or may be provided in both the upper flange portion 116 and the lower flange portion 114. In addition, only one pair of the concave-convex engaging portions 118 or a plurality of pairs of the concave-convex engaging portions 118 may be provided between flange portions (116a and 114a) of the first bobbin 111 and the flange portions (116b and 114b) of the second bobbin 112 that are in contact with each other.

Due to the first bobbin 111 and the second bobbin 112 meshing together by the concave-convex engaging portions 118, the first bobbin 111 and the second bobbin 112 are prevented from shifting in a transverse direction with respect to a meshing direction of the concave-convex engaging portions 118. Accordingly, the coil component 100 can be readily assembled in a stable manner.

In addition, since the engaging convex portion 118b has a shape that monotonously narrows in a protruding direction, when folding the first bobbin 111 and the second bobbin 112 to the folded state from the expanded state, the concave-convex engaging portions 118 can mesh together without interference between the engaging concave portion 118a and the engaging convex portion 118b.

In the present embodiment, the first bobbin 111 and the second bobbin 112 have a same shape including shapes of the concave-convex engaging portion 118 and a projecting portion 117 to be described later. Specifically, a position where the concave-convex engaging portion 118 is formed is provided on a side of the flange portion 116 in which the concave-convex engaging portion 118 is formed so as to be equidistant from a center of the side. In addition, the engaging concave portion 118a, the engaging convex portion 118b, and the projecting portion 117 in the first bobbin 111 and the second bobbin 112 are formed at positions and in shapes that are mutually rotationally symmetrical when the coil bobbin 10 is viewed in a longitudinal direction in the folded state.

Accordingly, the first bobbin 111 and the second bobbin 112 can be manufactured with a same manufacturing equipment and productivity of the coil bobbin 10 can be improved.

### (Coil Component)

Next, the coil component 100 including the coil bobbin 10 will be described.

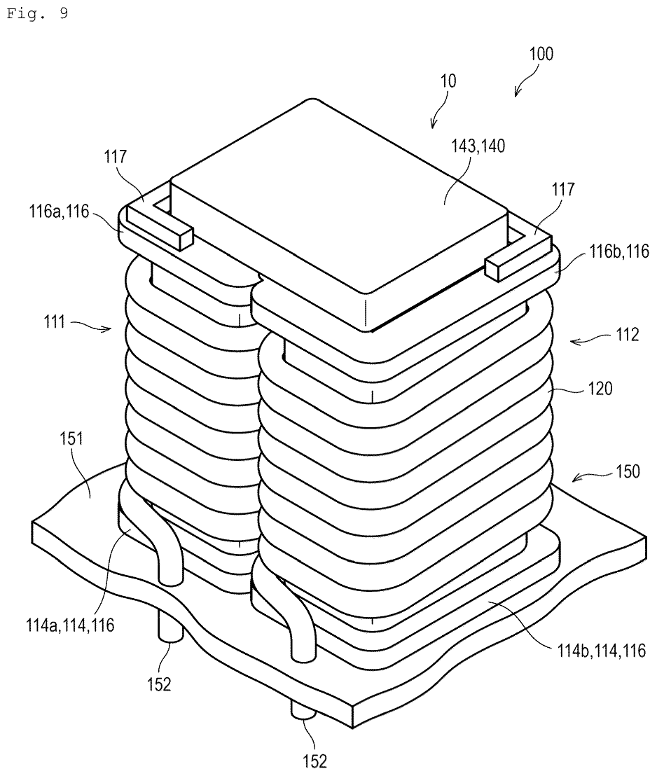

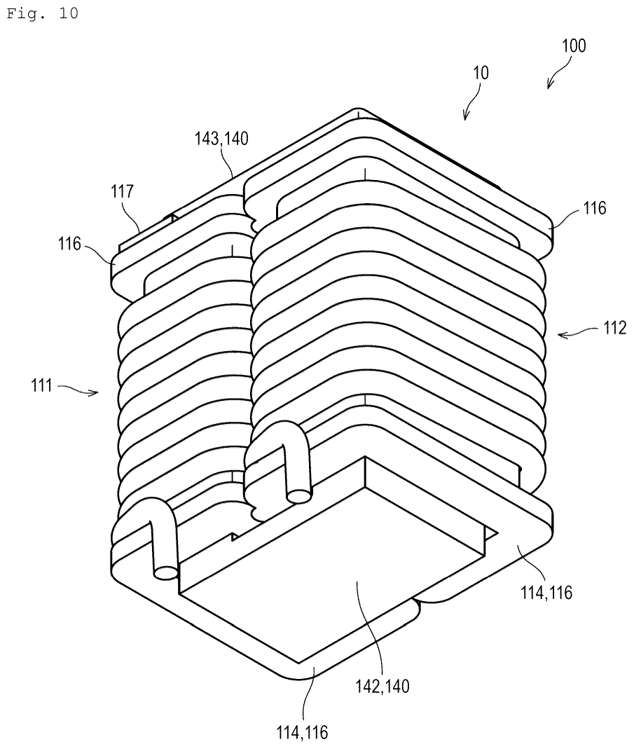

FIG. 9 is a perspective view of the coil component 100 and FIG. 10 is a perspective view of the coil component 100 from a different point of view. FIG. 11 is a longitudinal sectional view of the coil component 100.

The coil component 100 includes the core 140 constructed by combining the coil bobbin 10 described above with a plurality of magnetic members. As illustrated in FIG. 11, the core 140 includes a magnetic leg 141 inserted into each of the first bobbin 111 and the second bobbin 112 in a winding shaft direction of the winding 120. In this case, the coil component 100 according to the present embodiment refers to a component that is used including the coil bobbin 10. However, applications are not limited. The core 140 is made up of at least two magnetic members and the magnetic members are integrally molded using a magnetic material such as ferrite. In the present embodiment, while the core 140 is constituted of the U core 142 having a U-shape and the I core 143 having an I-shape, the core 140 is not limited thereto. For example, the core may be constituted of two U-shaped cores.

The first bobbin 111 and the second bobbin 112 are provided with insertion holes in the axial direction and an end of the U core 142 is inserted into respective insertion holes 119 of the first bobbin 111 and the second bobbin 112.

As described above, the first bobbin 111 and the second bobbin 112 include the winding shaft portion 113 around which the winding 120 is wound and the flange portions (116 and 114) that are formed at one end section and another end section of the first bobbin 111 and the second bobbin 112 and that protrude in a direction intersecting the axial direction from the winding shaft portion 113. The upper flange portion 116 includes the recessed portion 115.

The flange portion 116 at the one end section or the flange portion 116 at the other end section in each of the first bobbin 111 and the second bobbin 112 includes the projecting portion 117 on the outer surface 116c on an opposite side to the winding shaft portion 113. In other words, each of the upper flange portion 116a of the first bobbin 111 and the upper flange portion 116b of the second bobbin 112 includes the projecting portion 117 or each of the lower flange portion 114a of the first bobbin 111 and the lower flange portion 114b of the second bobbin 112 includes the projecting portion 117. In the present embodiment, the projecting portion 117 is provided in the upper flange portions 116 of the first bobbin 111 and the second bobbin 112.

The projecting portion 117 refers to a portion that protrudes to an opposite side to the winding shaft portion 113 from the outer surface 116c of the flange portion 116.

At least one of the magnetic members is arranged so as to straddle the flange portion 116 of the first bobbin 111 and the flange portion 116 of the second bobbin 112 and the projecting portion 117 is arranged in a periphery of the magnetic member. In this case, the magnetic member being arranged so as to straddle the flange portion 116 of the first bobbin 111 and the flange portion 116 of the second bobbin 112 means that a part of the magnetic member is in contact with the flange portion of the first bobbin 111 and another part is in contact with the flange portion 116 of the second bobbin 112. In the present embodiment, the I core 143 is in contact with the outer surface 116c in the respective upper flange portions 116 of the first bobbin 111 and the second bobbin 112.

In the present embodiment, as illustrated in FIG. 9, surfaces of the I core 143 in contact with the upper flange portion 116a of the first bobbin 111 and the upper flange portion 116b of the second bobbin 112 have a rectangular shape. The projecting portion 117 has an L-shape in which two intersecting straight lines are integrally formed, and while the projecting portion 117 is arranged so that the two straight lines are aligned with sides of the magnetic member, the projecting portion 117 is not limited thereto. The projecting portion 117 need only be arranged in a vicinity of each side of the I core 143 that is in contact with the flange portion 116 by a rectangular shape. For example, each of four sides may be provided with one projecting portion 117 or a plurality of projecting portions 117 arranged on a straight line along the side. In addition, the projecting portion 117 and the magnetic member (the I core 143) may be in contact with each other or may be adjacent to each other in a contactless manner.

While the projecting portion 117 is provided in the upper flange portion 116 in the present embodiment, the projecting portion 117 may be provided in the lower flange portion 114 instead. When the projecting portion 117 is provided in the upper flange portion 116, the projecting portions 117 of the first bobbin 111 and the second bobbin 112 are sandwiched between the outer surfaces 116c of the upper flange portions 116 of the first bobbin 111 and the second bobbin 112 in the expanded state. In addition, in the folded state, the I core 143 is arranged on the outer surface 116c of the upper flange portion 116 and the U core 142 is inserted from a lower end side of the coil bobbin 10. On the other hand, when the projecting portion 117 is provided in the lower flange portion 114, the outer surfaces 116c of the upper flange portions 116 of the first bobbin 111 and the second bobbin 112 come into contact with each other in the expanded state. In addition, in the folded state, the I core 143 is arranged on the outer surface 116c of the lower flange portion 114 and the U core 142 is inserted from an upper end side of the coil bobbin 10.

By providing the projecting portion 117 in the lower flange portions 114 of the first bobbin 111 and the second bobbin 112, a distance between upper flange portions 116 of the first bobbin 111 and the second bobbin 112 in the expanded state decreases and a length of the traverse portion 122 that traverses from the recessed portion 115 of the first bobbin 111 to the recessed portion 115 of the second bobbin 112 can be reduced. Accordingly, the length of the slack portion 121 is reduced and the winding 120 can be prevented from unexpectedly emerging outside of the coil component 100 in the folded state.

When the projecting portion 117 is provided in the upper flange portions 116 of the first bobbin 111 and the second bobbin 112, by inserting the U core 142 from the lower end side of the coil bobbin 10, the first bobbin 111 and the second bobbin 112 can be readily prevented from returning to the expanded state from the folded state. This is because rotation of the first bobbin 111 and the second bobbin 112 can be regulated at a center around which the first bobbin 111 and the second bobbin 112 are folded or, in other words, the U core 142 on the lower end side that is distanced from the upper end side where the traverse portion 122 is present.

In addition, when the projecting portion 117 is provided in the upper flange portions 116, a depth of the recessed portion 115 may be set to half or more of a height of the projecting portion 117. In this case, the height of the projecting portion 117 is a height toward an outer side in the axial direction based on a surface of the flange portion 116 in the projecting portion 117. Providing the projecting portion 117 in the upper flange portion 116 increases a length of the traverse portion 122 of the winding 120 to be described later by the height of the projecting portion 117. Setting the depth of the recessed portion 115 to half or more of the height of the projecting portion 117 reduces an increase in the length of the traverse portion 122 due to the height of the projecting portion 117.

By arranging the magnetic member on the flange portion 116 of the first bobbin 111 and the flange portion 116 of the second bobbin 112 and arranging the projecting portion 117 in a periphery of the magnetic member, the magnetic member is positioned and a transverse shift of the magnetic member on the flange portions 116 (116a and 114a) of the first bobbin 111 and the flange portions 116 (116b and 114b) of the second bobbin 112 is prevented. Accordingly, the coil component 100 can be readily assembled in a stable manner.

### (Terminal Portion)

As shown in FIG. 9, the coil component 100 includes a terminal portion 150. Both ends of the winding 120 are electrically connected and mounted to an electronic substrate (not illustrated) by the terminal portion 150. As an example of a method of mounting the winding 120 to the electronic substrate, the winding 120 is directly mounted to the electronic substrate by soldering or the like.

Specifically, the terminal portion 150 is configured as described below. The terminal portion 150 includes a mounting stand 151 and the mounting stand 151 is arranged parallel to the flange portion 116 on a lower side of the coil component. Both ends of the winding 120 are drawn out from the winding shaft portion 113 of the first bobbin 111 or the second bobbin 112 to below the flange portion 116, made to penetrate the mounting stand 151, and drawn out to below the mounting stand 151. The mounting stand 151 and the coil component 100 are fixed by a sealing material such as a resin to be described later. Both ends of the winding 120 are arranged so as to be parallel to each other and mounted to the electronic substrate as rod-shaped terminals 152 by soldering or the like. Alternatively, drawn-out tips of the winding 120 may be stretched and spread so as to become surfaces parallel to the mounting stand 151 and the stretched and spread surfaces may be mounted to the electronic substrate as surface-mount terminals 152 by soldering or the like.

A method of mounting to the electronic substrate is not limited to a method of connecting the winding 120 to the electronic substrate as terminals 152. For example, the coil component 100 may be provided with a connection terminal electrically-connected to a mounting terminal and the connection terminal and the winding 120 may be electrically-connected by connecting each of both ends of the winding 120 to a corresponding connection terminal. The mounting terminal is bonded to the electronic substrate by soldering or the like.

The coil bobbin 10 according to the present embodiment can also be provided as two bobbins 110 (the first bobbin 111 and the second bobbin 112) without including the winding 120 and the core 140. As described above, the coil bobbin 10 according to the present embodiment includes two bobbins 110 (the first bobbin 111 and the second bobbin 112). The bobbins 110 include a projecting region that extends in a circumferential direction of the winding shaft portion 113 around which the winding 120 is wound at one end section of the bobbins 110. The projecting region is provided with the recessed portion 115 that is formed in a recessed shape from an outer circumferential edge of the projecting region toward the winding shaft portion 113 of the bobbins. The bobbins 110 include the concave-convex engaging portion 118. The concave-convex engaging portions 118 engage with each other in a state where the two bobbins 110 (the first bobbin 111 and the second bobbin 112) are arranged side by side so that axial directions are aligned with each other and the recessed portions 115 inwardly oppose each other with respect to a space sandwiched between the two bobbins 110.

The coil bobbin 10 enables the winding 120 to be wound and the coil bobbin 10 to be readily manufactured by the method of manufacturing the coil bobbin 10 to be described later. In other words, by passing the winding 120 through the recessed portions 115 in the winding step, a position of the winding 120 that traverses from the first bobbin 111 to the second bobbin 112 can be determined within a certain range. Accordingly, a transverse shift of the winding 120 in the folding step in which the first bobbin 111 and the second bobbin 112 are folded so as to be arranged side by side can be prevented.

In addition, by providing the projecting region, a situation where the winding 120 becomes loose toward an opposite side to the winding shaft portion 113 from the projecting region can be prevented.

Furthermore, including the concave-convex engaging portions 118 enables a transverse shift of the first bobbin 111 and the second bobbin 112 in the folded state to be prevented and the coil component 100 to be readily assembled.

### (Method of Manufacturing Coil Bobbin)

Next, an overview of the method of manufacturing the coil bobbin 10 described above will be described.

The coil bobbin 10 includes: the winding 120; and the first bobbin 111 and the second bobbin 112 respectively including the winding shaft portion 113 around which the winding 120 is wound and being arranged side by side. The method of manufacturing the coil bobbin 10 includes a winding step and a folding step. In the winding step, in a state where the first bobbin 111 and the second bobbin 112 are vertically arranged so that the respective winding shaft portions 113 are aligned in an approximately linear shape, the winding 120 is wound in a continuous manner around the winding shaft portion 113 of the first bobbin 111 and the winding shaft portion 113 of the second bobbin 112. In the folding step, the first bobbin 111 and the second bobbin 112 are folded and arranged side by side so that the traverse portion 122 being a length region that straddles the first bobbin 111 and the second bobbin 112 in the winding 120 is positioned inside.

Next, details of the method of manufacturing the coil bobbin 10 will be described.

As described above, the first bobbin 111 and the second bobbin 112 include a projecting region that extends in the circumferential direction of the winding shaft portion 113 in at least one end section and the projecting region includes the recessed portion 115 that is formed in a recessed shape from an outer circumferential edge of the projecting region toward the winding shaft portion 113. The projecting region is provided in the one end section on a side with which the first bobbin 111 and the second bobbin 112 come into contact.

In the winding step of the winding, as shown in FIGS. 7 and 8, the one end sections of the first bobbin 111 and the second bobbin 112 are in contact with each other and the first bobbin 111 and the second bobbin 112 are arranged in a linear shape so that the recessed portions 115 of the first bobbin 111 and the second bobbin 112 are positioned on a same side in a circumferential direction of the winding shaft portion 113. In this case, the recessed portions 115 of the first bobbin 111 and the second bobbin 112 being positioned on a same side in the circumferential direction of the winding shaft portion 113 means that opening directions of the recessed portions 115 of the first bobbin 111 and the second bobbin 112 are approximately the same. Specifically, this means that the openings of the recessed portions 115 of the first bobbin 111 and the second bobbin 112 can be viewed at once when the first bobbin 111 and the second bobbin 112 are viewed from any of transverse directions that are orthogonal to the winding shaft direction in the expanded state of the first bobbin 111 and the second bobbin 112. Preferably, the recessed portions 115 of the first bobbin 111 and the second bobbin 112 communicate with each other. In other words, when viewed from the axial direction of the first bobbin 111 and the second bobbin 112, at least a part of the recessed portion 115 of the first bobbin 111 and the recessed portion 115 of the second bobbin 112 overlap with each other. When the recessed portions of the first bobbin 111 and the second bobbin 112 communicate with each other, a distance between the recessed portion 115 of the first bobbin 111 and the recessed portion 115 of the second bobbin 112 can be reduced as compared to a case where the recessed portions 115 are not communicated and a length of the slack portion 121 can be reduced.

When the winding 120 is thinner than a height of the projecting portion 117, the recessed portions 115 of the first bobbin 111 and the second bobbin 112 need not communicate with each other in the folded state and may be shifted in the circumferential direction or the radial direction.

As shown in FIG. 8, in the winding step of the winding 120, the traverse portion 122 is passed through the recessed portions 115 of the first bobbin 111 and the second bobbin 112 and the winding 120 is wound in a continuous manner around the winding shaft portion 113 of the first bobbin 111 and the winding shaft portion 113 of the second bobbin 112. Specifically, for example, the winding 120 is wound from one end (a left end in FIG. 8) to another end (a right end in FIG. 8) of the first bobbin 111 and traverses from the first bobbin 111 to the second bobbin 112 through the recessed portion 115 of the first bobbin 111. Furthermore, the winding 120 passes through the recessed portion 115 of the second bobbin 112 and is wound in a continuous manner from one end (a left end in FIG. 8) to another end (a right end in FIG. 8) of the second bobbin 112.

In this case, the traverse portion 122 of the winding 120 refers to a length region of the winding 120 that is sandwiched between the winding 120 wound around the first winding shaft portion 113a and the winding 120 wound around the second winding shaft portion 113b. In the present embodiment, the traverse portion 122 refers to a length region that traverses from the recessed portion 115 of the first bobbin 111 to the recessed portion 115 of the second bobbin 112.

In the folding step, the first bobbin 111 and the second bobbin 112 are folded so that the traverse portion 122 is positioned inside or, in other words, the recessed portions 115 of the first bobbin 111 and the second bobbin 112 are positioned inside. In this case, the first bobbin 111 and the second bobbin 112 having been arranged in an approximately linear shape are rotated by approximately 180 degrees without being twisted until the first bobbin 111 and the second bobbin 112 are arranged side by side so that axial directions are aligned with each other.

When the coil bobbin 10 is folded, the plurality of magnetic members described above are inserted or arranged and the terminal portion 150 described above is provided. As illustrated in FIG. 2, the winding 120 may protrude outside from the outer surface 116c of the flange portion 116 through the recessed portion 115 (refer to FIG. 1). In this case, due to the winding 120 protruding from the outer surface 116c of the flange portion 116, the I core 143 and the outer surface 116c of the flange portion 116 are unable to come into contact with each other in a stable manner and an adhesion failure between the I core 143 and the flange portion 116 may occur. In order to avoid such a situation, the winding 120 protruding outside from the outer surface 116c of the flange portion 116 may be pushed toward the side of the winding shaft portion 113 and the I core 143 may be arranged in a state where the winding 120 does not protrude above the outer surface 116c of the flange portion 116 as shown in FIG. 4.

The I core 143 that is a magnetic member may be fixed to the flange portion 116 by an adhesive. In addition, the mounting stand 151 and the U core 142 may be fixed to the coil bobbin 10 by an adhesive. Furthermore, portions other than the terminals 152 may be coated by a sealing material such as an epoxy resin or a polyester resin.

As described above, both end sections of the winding 120 are electrically-connected to the electronic substrate.

In this case, when attempting to wind the winding 120 around the first bobbin 111 in a state where the first bobbin 111 and the second bobbin 112 are arranged side by side, a wire rod supplying unit of a winding apparatus readily interferes with the second bobbin 112 that is present in proximity in the radial direction of the first bobbin 111. Therefore, since the winding 120 needs to be wound while avoiding interference between the second bobbin 112 and the wire rod supplying unit in order to wind the winding 120 in a state where the first bobbin 111 and the second bobbin 112 are close to each other, efficiency of the winding step of the winding 120 declines.

When winding the winding 120 around the first bobbin 111 in a state where the winding shaft portions 113 of the first bobbin 111 and the second bobbin 112 are arranged so as to be aligned in a linear shape, since the second bobbin 112 is not present in the radial direction of the first bobbin 111, interference between the second bobbin 112 and the wire rod supplying unit is prevented. Accordingly, the winding 120 can be wound in a continuous manner from the first bobbin 111 to the second bobbin 112 and the efficiency of the winding step of the winding 120 can be increased.

In addition, since the first bobbin 111 and the second bobbin 112 are folded and arranged side by side while being brought close to each other after the winding 120 is wound, a gap between the first bobbin 111 and the second bobbin 112 can be freely adjusted. In other words, the coil bobbin 10 can be downsized by reducing the gap between the first bobbin 111 and the second bobbin 112.

Furthermore, when attempting to sequentially wind the winding 120 around each of the first bobbin 111 and the second bobbin 112 in a state where the first bobbin 111 and the second bobbin 112 are arranged side by side, directions in which the winding is wound must be switched between the first bobbin 111 and the second bobbin 112. In other words, the winding 120 must be wound in opposite directions between the first winding shaft portion 113a and the second winding shaft portion 113b. This is done in order to wind the winding 120 in a same direction with respect to a direction of a line of magnetic force that passes through a closed magnetic circuit formed by the magnetic member. On the other hand, when the winding 120 is wound while placing the first bobbin 111 and the second bobbin 112 in the expanded state, the winding 120 is wound in a same direction both when winding the winding 120 around the first bobbin 111 and when winding the winding 120 around the second bobbin 112 and winding directions need not be switched. In addition, by folding the first bobbin 111 and the second bobbin 112, the winding directions of the winding 120 in the first winding shaft portion 113a and the second winding shaft portion 113b naturally become opposite directions. Since there is no need to switch winding directions of the winding 120 as described above, efficiency of the winding step can be increased.

By providing the recessed portions 115 at end sections on a side that is brought into contact in the expanded state of the first bobbin 111 and the second bobbin 112, a position of the winding 120 that traverses from the first bobbin 111 to the second bobbin 112 can be determined within a certain range. Accordingly, a transverse shift of the winding 120 in the folding step can be prevented and a folding position of the winding 120 in the coil bobbin 10 to be manufactured can be kept constant.

The present invention is not limited to the embodiment described above and includes aspects of various modifications, improvements, and the like insofar as the object of the present invention is achieved.

The first embodiment described above may adopt an aspect in which the first bobbin 111 and the second bobbin 112 do not include a projecting region such as the flange portion 116. In this case, the winding 120 traverses between the first bobbin 111 and the second bobbin 112 from any location in the first bobbin 111 and the second bobbin 112.

The coil bobbin 10 may include three or more bobbins 110. In other words, the three or more bobbins 110 may be arranged in a linear shape and the winding 120 may be wound in a continuous manner in the winding step and two or more locations may be folded so that the traverse portion 122 is positioned inside in the folding step. For example, when the winding 120 is wound around three bobbins 110, the three bobbins 110 are folded so as to be arranged in a triangle, and when the winding 120 is wound around four bobbins 110, the four bobbins 110 are folded so as to be arranged in a square. Accordingly, the winding 120 can be wound around all sides of a closed magnetic circuit with a polygonal shape.

The winding 120 may be wound around the bobbins 110 to form multiple layers. By winding the winding 120 in an odd number of layers such as three layers or five layers, the terminal portions 150 can be constructed by arranging both ends of the winding 120 at the lower end of the coil bobbin 10 and the winding 120 can be made to traverse from the first bobbin 111 to the second bobbin 112 at the upper end of the coil bobbin 10.

In addition, the winding 120 may be wound in plurality around the bobbins 110. In this case, the plurality of windings 120 may be wound in an overlapping manner or may be respectively wound around different positions in the winding shaft direction of the winding shaft portion 113. In other words, the winding position on the winding shaft portion 113 may be differentiated for each winding 120. In this case, in order to partition winding positions of the windings 120, a flange may be provided midway along a length direction of the winding shaft portion 113, one winding 120 may be wound around one side of the flange, and another winding 120 may be wound around the other side of the flange. In addition, the concave-convex engaging portion 118 may be formed on the flange.

The embodiment described above covers the following technical ideas.
(1) A coil bobbin, comprising: a winding; and a first bobbin and a second bobbin arranged side by side so that axial directions are aligned with each other, wherein the winding: is wound in a continuous manner around the first bobbin and the second bobbin; made to traverse from the first bobbin to the second bobbin through an inside space sandwiched between the first bobbin and the second bobbin arranged side by side; and includes a slack portion in the inside space.
(2) The coil bobbin according to (1), wherein the first bobbin and the second bobbin include: a winding shaft portion around which the winding is wound; and a projecting region extending in a circumferential direction of the winding shaft portion at one end section of the first bobbin and the second bobbin, the projecting region includes a recessed portion formed in a recessed shape from an outer circumferential edge of the projecting region toward the winding shaft portion, and the first bobbin and the second bobbin are arranged so that at least a part of the respective recessed portions is inside between the first bobbin and the second bobbin.
(3) The coil bobbin according to (2), wherein the slack portion has a length that enables the winding to traverse from the first bobbin to the second bobbin through the recessed portions when the first bobbin and the second bobbin are arranged in a linear shape by bringing the one end sections provided with the projecting region into contact with each other.
(4) The coil bobbin according to (3), wherein the length of the slack portion is equal to or more than a length of a sum of a height of a bottom of the recessed portion from a circumferential surface of the winding shaft portion in the first bobbin, a height of the bottom of the recessed portion in the second bobbin, and a distance from the recessed portion of the first bobbin to the recessed portion of the second bobbin in a case where the first bobbin and the second bobbin are arranged in a linear shape by bringing the one end sections provided with the projecting region into contact with each other.
(5) The coil bobbin according to any one of (2) to (4), wherein the projecting region is a flange portion that protrudes in a direction intersecting the axial direction from the winding shaft portion of the first bobbin or the second bobbin, and the winding is made to traverse from the first bobbin to the second bobbin more to a side of the winding shaft portion than an outer surface of the flange portion.
(6) The coil bobbin according to any one of (1) to (5), wherein the first bobbin and the second bobbin include concave-convex engaging portions that engage with each other in a state where the first bobbin and the second bobbin are arranged side by side so that axial directions are aligned with each other.
(7) A coil component, comprising: the coil bobbin according to any one of (1) to (6); and a core that includes a magnetic leg inserted into each of the first bobbin and the second bobbin in a winding shaft direction of the winding and that is constructed by combining a plurality of magnetic members, wherein the first bobbin and the second bobbin include: a winding shaft portion around which the winding is wound; and a flange portion that is respectively formed at one end section and another end section of the first bobbin and the second bobbin and that protrudes in a direction intersecting the axial direction from the winding shaft portion, the flange portion at the one end section or the flange portion at the other end section in each of the first bobbin and the second bobbin includes a projecting portion on an outside surface on an opposite side to the winding shaft portion, and at least one of the magnetic members is arranged so as to straddle the flange portion of the first bobbin and the flange portion of the second bobbin and the projecting portion is arranged in a periphery of the magnetic member.
(8) A coil bobbin comprising two bobbins, wherein the bobbins include a projecting region that extends in a circumferential direction of a winding shaft portion around which a winding is wound at one end section of the bobbins, the projecting region is provided with a recessed portion formed in a recessed shape from an outer circumferential edge of the projecting region toward the winding shaft portion of the bobbins, the bobbins are arranged side by side so that axial directions of the two bobbins are aligned with each other, and the bobbins include concave-convex engaging portions that engage with each other in a state where the recessed portions inwardly oppose each other with respect to a space sandwiched between the two bobbins.
(9) A method of manufacturing a coil bobbin including a winding and a first bobbin and a second bobbin that respectively include a winding shaft portion around which the winding is to be wound and that are arranged side by side, the method of manufacturing a coil bobbin comprising: winding the winding in a continuous manner around the winding shaft portion of the first bobbin and the winding shaft portion of the second bobbin in a state where the first bobbin and the second bobbin are vertically arranged so that the respective winding shaft portions are aligned in an approximately linear shape; and folding and arranging the first bobbin and the second bobbin side by side so that a traverse portion being a length region that straddles the first bobbin and the second bobbin in the winding is positioned inside.
(10) The method of manufacturing a coil bobbin according to (9), wherein the first bobbin and the second bobbin include: a projecting region extending in a circumferential direction of the winding shaft portion in at least one end section, the projecting region includes a recessed portion formed in a recessed shape from an outer circumferential edge of the projecting region toward the winding shaft portion, and said winding the winding includes bringing the one end sections in contact with each other, arranging the first bobbin and the second bobbin in a linear shape so that the recessed portions are positioned on a same side in a circumferential direction of the winding shaft portion, and winding the winding in a continuous manner by making the traverse portion traverse from the winding shaft portion of the first bobbin to the winding shaft portion of the second bobbin through the recessed portions of the first bobbin and the second bobbin.

1. A coil bobbin, comprising:
a winding; and a first bobbin and a second bobbin arranged side by side so that axial directions are aligned with each other, wherein
the winding:
is wound in a continuous manner around the first bobbin and the second bobbin;
made to traverse from the first bobbin to the second bobbin through an inside space sandwiched between the first bobbin and the second bobbin arranged side by side; and
includes a slack portion in the inside space.

2. The coil bobbin according to claim 1, wherein
the first bobbin and the second bobbin include:
a winding shaft portion around which the winding is wound; and
a projecting region extending in a circumferential direction of the winding shaft portion at one end section of the first bobbin and the second bobbin,
the projecting region includes
a recessed portion formed in a recessed shape from an outer circumferential edge of the projecting region toward the winding shaft portion, and
the first bobbin and the second bobbin are
arranged so that at least a part of the respective recessed portions is inside between the first bobbin and the second bobbin.

3. The coil bobbin according to claim 2, wherein
the slack portion has
a length that enables the winding to traverse from the first bobbin to the second bobbin through the recessed portions when the first bobbin and the second bobbin are arranged in a linear shape by bringing the one end sections provided with the projecting region into contact with each other.

4. The coil bobbin according to claim 3, wherein
the length of the slack portion is
equal to or more than a length of a sum of a height of a bottom of the recessed portion from a circumferential surface of the winding shaft portion in the first bobbin, a height of the bottom of the recessed portion in the second bobbin, and a distance from the recessed portion of the first bobbin to the recessed portion of the second bobbin in a case where the first bobbin and the second bobbin are arranged in a linear shape by bringing the one end sections provided with the projecting region into contact with each other.

5. The coil bobbin according to claim 2, wherein
the projecting region is
a flange portion that protrudes in a direction intersecting the axial direction from the winding shaft portion of the first bobbin or the second bobbin, and
the winding is
made to traverse from the first bobbin to the second bobbin more to a side of the winding shaft portion than an outer surface of the flange portion.

6. The coil bobbin according to claim 1, wherein
the first bobbin and the second bobbin include
concave-convex engaging portions that engage with each other in a state where the first bobbin and the second bobbin are arranged side by side so that axial directions are aligned with each other.

7. A coil component, comprising:
the coil bobbin according to claim 1; and
a core that includes a magnetic leg inserted into each of the first bobbin and the second bobbin in a winding shaft direction of the winding and that is constructed by combining a plurality of magnetic members, wherein
the first bobbin and the second bobbin include:
a winding shaft portion around which the winding is wound; and
a flange portion that is respectively formed at one end section and another end section of the first bobbin and the second bobbin and that protrudes in a direction intersecting the axial direction from the winding shaft portion,
the flange portion at the one end section or the flange portion at the other end section in each of the first bobbin and the second bobbin includes
a projecting portion on an outside surface on an opposite side to the winding shaft portion, and
at least one of the magnetic members is
arranged so as to straddle the flange portion of the first bobbin and the flange portion of the second bobbin and the projecting portion is arranged in a periphery of the magnetic member.

8. A coil bobbin comprising two bobbins, wherein
the bobbins include
a projecting region that extends in a circumferential direction of a winding shaft portion around which a winding is wound at one end section of the bobbins,
the projecting region is
provided with a recessed portion formed in a recessed shape from an outer circumferential edge of the projecting region toward the winding shaft portion of the bobbins,
the bobbins are
arranged side by side so that axial directions of the two bobbins are aligned with each other, and the bobbins include concave-convex engaging portions that engage with each other in a state where the recessed portions inwardly oppose each other with respect to a space sandwiched between the two bobbins.

9. A method of manufacturing a coil bobbin including a winding and a first bobbin and a second bobbin that respectively include a winding shaft portion around which the winding is to be wound and that are arranged side by side, the method of manufacturing a coil bobbin comprising:
winding the winding in a continuous manner around the winding shaft portion of the first bobbin and the winding shaft portion of the second bobbin in a state where the first bobbin and the second bobbin are vertically arranged so that the respective winding shaft portions are aligned in an approximately linear shape; and
folding and arranging the first bobbin and the second bobbin side by side so that a traverse portion being a length region that straddles the first bobbin and the second bobbin in the winding is positioned inside.

10. The method of manufacturing a coil bobbin according to claim 9, wherein
the first bobbin and the second bobbin include:
a projecting region extending in a circumferential direction of the winding shaft portion in at least one end section,
the projecting region includes
a recessed portion formed in a recessed shape from an outer circumferential edge of the projecting region toward the winding shaft portion, and
said winding the winding includes bringing the one end sections in contact with each other, arranging the first bobbin and the second bobbin in a linear shape so that the recessed portions are positioned on a same side in a circumferential direction of the winding shaft portion, and winding the winding in a continuous manner by making the traverse portion traverse from the winding shaft portion of the first bobbin to the winding shaft portion of the second bobbin through the recessed portions of the first bobbin and the second bobbin.
